(19) United States
(12) Patent Application Publication
(10) Pub. No.: US 2022/0177725 A1
(43) Pub. Date: Jun. 9, 2022

(54) SOLVENT-FREE MATT POLYUREA COATING AND KIT OF PARTS FOR PRODUCING THE COATING

(71) Applicant: SHENZHEN YUANJINGANG NEW MATERIALS CO., LTD. (CN), SHENZHEN (CN)

(72) Inventors: Jan Dietrich, SHENZHEN (CN); Tiantian Chi, SHENZHEN (CN); Wusong Li, SHENZHEN (CN); Ping Li, SHENZHEN (CN); Rui Huang, SHENZHEN (CN)

(21) Appl. No.: 17/678,862

(22) Filed: Feb. 23, 2022

Related U.S. Application Data
(63) Continuation of application No. PCT/CN2020/111784, filed on Aug. 27, 2020.

(30) Foreign Application Priority Data
Aug. 30, 2019 (DE) 202019104767.4

(51) Int. Cl. C09D 175/02; C08G 18/32; C08G 18/50

(52) U.S. Cl. CPC C09D 175/02; C08G 18/5024; C08G 18/324

(57) ABSTRACT

The present application relates to a solvent-free matt polyurea coating which is obtained by carrying out a reaction through reacting at least following components: a) a polyisocyanate prepolymer; b) a polyether amine; c) a main chain extender, wherein the coating further comprises ground carbon fibers as a matting agent. The carbon fibers have an average fiber length greater than or equal to 50 μm and less than or equal to 150 μm, a weight fraction greater than or equal to 4.5% and less than or equal to 25%. The present application also relates to a kit of parts for producing a solvent-free matt polyurea coating.

### CROSS-REFERENCE TO RELATED APPLICATIONS

The present application is a continuation of PCT/CN2020/111784 filed on Aug. 27, 2020, entitled “Solvent-Free Matt Polyurea Coating and Kit of Parts for Producing the Coating”, which claims the priority of German Utility Model Patent No. 202019104767.4 filed on Aug. 30, 2019, entitled “Solvent-Free Matt Polyurea Coating”, the entirety of the above identified applications is incorporated herein by reference.

### TECHNICAL FIELD

The present application relates to the technical field of coating, and in particular to a solvent-free matt polyurea coating and a kit of parts for producing the coating.

### BACKGROUND ART

A Polymer is, a molecule composed of repeatable molecular units called monomers; and its functional characteristics not only depend on a complex parameter matrix, but also on synthesis conditions, production processes, processing modes and auxiliaries used. The latter may greatly influence the properties such as, ultraviolet ray stability, color and thermic stability and machinability, and the former has a significant impact on basic properties of a polymer. Thereby, for instance, mechanical properties of polymers can be specifically regulated to a required level within a wide range by such a correlation, such that these substances provide targeted solutions for the extensive use thereof in fields such as, medicine, cosmetics, building materials, corrosion prevention and consumables industry.

Since base materials of a polymer can be used for producing a coating layer having a very high layer thickness and particularly advantageous mechanical properties, polyurea materials are particularly suitable for functional applications. Specifically, polyurea is considered as a reaction system having rapid reaction kinetics and thus, can provide service time within a few seconds in most applications. A system with obviously reduced reaction activity can be further established by adding other substances, such as secondary amine, thus making manual operations feasible. The obtained polyurea coating layer has good and even excellent chemical resistance as well as high elasticity and tear resistance. But on the other hand, it is very difficult to obtain a polyurea coating layer having special surface properties; because the addition of other substances affecting surface appearance will usually disturb the basic mechanical properties of the coating, the coating may hardly maintain the required mechanical properties, but change the surface properties thereof only.

The existing patent documents contain multiple options for the regulation of surface properties of polyurea; and the regulation of surface properties is achieved by adjusting the monomeric units used or by adding other additives.

For example, EP 2 953 990 B1 discloses a non-aqueous coating composition, comprising:

A. an isocyanate reactive agent, comprising at least one secondary diamine; the secondary diamine is a reaction product of at least one diamine and alkyl esters of 2-butendioic acid;

B. at least one polyisocyanate resin;

C. at least one gloss reducing agent; and

D. at least one viscosity modifier; wherein C) and D) comprise less than about 35% of the total coating formulation; and the gloss reducing agent comprises a fine-grained, organic treated precipitated silica.

Furthermore, EP 2 588 509 B1 discloses an aliphatic polyurea coating, comprising a product mixed by the components including A, B and C:

A) 30-50 parts by weight of NCO-terminated polycarbonate diol modified and/or polyether polyol-modified isophorone diisocyanate (IPDI) prepolymer;

B) 3-15 parts by weight of hexamethylene diisocyanate (HDI) oligomers; and

C) 10-25 parts by weight of amino resin comprising sterically hindered secondary aliphatic diamines.

Another patent document EP 2 463 340 A1 relates to a conventional functionalized treatment of polyurea. The document discloses use of a nucleating agent in the production of a polyurea adduct by at least one amine and at least one isocyanate; the nucleating agent is not isomorphic to the polyurea adduct prepared by at least one amine and at least one isocyanate.

Even though there exists a possibility for adjusting the properties of a polyurea coating layer, people are still very interested in the technical solution capable of satisfying the requirements of mechanical properties and matt surface state simultaneously, in particular to a definite and effective means with reproducible results.

### SUMMARY OF THE INVENTION

One objective of the present application is to provide a polyurea coating with improved mechanical properties and a matt surface and a kit of parts for producing the coating.

One aspect of the present application is to provide a solvent-free matt polyurea coating which is obtained by carrying out a reaction through at least following components:

a) a polyisocyanate prepolymer;

b) a polyether amine;

c) a main chain extender, wherein

the coating further comprises ground carbon fibers as a matting agent, the carbon fibers have an average fiber length greater than or equal to 50 μm and less than or equal to 150 μm, a weight fraction greater than or equal to 4.5% and less than or equal to 25%; the main chain extender is selected from one or a combination of two or more of diethyltoluenediamine, 4,4-methylene bis(N-sec-butyl-cyclohexylamine), 4,4-diaminodiphenylmethane, 4,4-diaminodicyclohexylmethane, 3-[[3-[[(2-cyanoethyl)amino]methyl-3,5,5-trimethylcyclohexyl]amino]propionitrile and 1,3-cyclohexyldimethylamine.

Preferably, the polyisocyanate prepolymer is a polyfunctional polyisocyanate prepolymer having at least two or more isocyanate functionalities.

Preferably, the polyisocyanate prepolymer is selected from one or a combination of two or more of toluene-2,4-diisocyanate (TDI), diphenylmethane diisocyanate (MDI), hexamethylene diisocyanate (HDI, HMDI), polymerized diphenylmethane diisocyanate (PMDI), tetramethyl m-xylylene diisocyanate (TMXDI), isophorone diisocyanate (IPDI) and 4,4′-dicyclohexylmethane diisocyanate (H12MDI).

Preferably, the polyether amine is a polyfunctional polyether amine having at least two or more amine functionalities, and has a molecular weight of 200-5000 g/mol.

Preferably, a molar ratio of amine to isocyanate in the coating is 1-4.

Preferably, the coating has a glossiness greater than or equal to 10 and less than or equal to 70 measured at 600 according to DIN EN ISO 2813.

Preferably, the coating has a glossiness greater than or equal to 10 and less than or equal to 70 measured at 85° according to DIN EN ISO 2813.

Preferably, the ground carbon fibers have a weight fraction greater than or equal to fraction 7.5% and less than or equal to 15%.

Preferably, the coating further comprises a steric hindrance amine resin having a weight fraction greater than or equal to fraction 2.5% and less than or equal to 10%.

Preferably, the coating further comprises one or a combination of two or more of degassing agent, dispersing agent, UV stabilizer, pigment and filler.

Preferably, the ground carbon fibers have an average fiber diameter greater than or equal to 2.5 μm and less than or equal to 10 μm.

Preferably, the coating has a solvent content less than or equal to 1%.

Preferably, based on a weight fraction, the coating has a content of polyisocyanate greater than or equal to 30% and less than or equal to 50%, a content of polyether amine greater than or equal to 20% and less than or equal to 80%, a content of chain extender greater than or equal to 5% and less than or equal to 40%, and a content of the matting agent in form of the ground carbon fibers greater than or equal to 5% and less than or equal to 10%; where each component may exist in form of a reaction product with each other.

Preferably, the reaction is performed by an atomizing spray process.

Another aspect of the present application is to provide a kit of parts for producing a solvent-free matt polyurea coating; the kit at least comprises a container used for polyfunctional polyisocyanate prepolymer, a container used for polyether amine, as well as a mixing device and an extruding device; at least one of the above containers contains ground carbon fibers greater than or equal to 2.5 wt % and less than or equal to 20 wt %, and a fiber length of the carbon fibers is greater than or equal to 50 μm and less than or equal to 150 μm.

Compared with the prior art, the present application has the following beneficial effects:

(1) The solvent-free matt polyurea coating provided by the preset application, by adding ground carbon fibers as a matting agent, enables the coating layer coated by the coating to have a matt surface besides excellent mechanical properties.

(2) Directed to carbon fibers, the present application puts forward a novel use way thereof as a matting agent, thus overcoming a limitation to carbon fibers in the prior art and obtaining an unexpected matt effect.

(3) The coating provided herein has no addition of a solvent and thus, is regarded free of solvent.

(4) The present application can prolong the reaction time by regulating the functionalities of the polyisocyanate prepolymer and polyether amine or a proportion of each component, making a manual application of the coating feasible.

(5) The present application is beneficial to forming a perdurable coating layer by adding a steric hindrance amine resin, thus extending a service life of the coating layer.

(6) The kit of parts for producing the solvent-free matt polyurea coating provided by the present application can provide a highly-reproducible and reliable matt polyurea coating layer in the application of manual or machinery equipment.

### DETAILED DESCRIPTION OF THE INVENTION

The technical solutions in detailed embodiments of the present application will be described specifically and completely. Apparently, the embodiments described are merely partial detailed embodiments of the general technical solution herein, but are not all the embodiments. Based on the general idea of the present invention, all the other embodiments obtained by a person skilled in the art shall fall within the protection scope of the present invention.

The embodiments of the present application provide a solvent-free matt polyurea coating which is obtained by carrying out a reaction through at least following components:

a) a polyisocyanate prepolymer;

b) a polyether amine;

c) a main chain extender, wherein,

the coating further comprises ground carbon fibers as a matting agent; the carbon fibers have an average fiber length greater than or equal to 50 μm and less than or equal to 150 μm, a weight fraction greater than or equal to 4.5% and less than or equal to 25%; the main chain extender is selected from one or a combination of two or more of diethyltoluenediamine, 4,4-methylene bis(N-sec-butyl-cyclohexylamine), 4,4-diaminodiphenylmethane, 4,4-diaminodicyclohexylmethane, 3-[[3-[[(2-cyanoethyl)amino]methyl-3,5,5-trimethylcyclohexyl]amino]propionitrile, N,N′-isopropyl (3-aminomethyl-3,5,5-trimethylcyclohexylamine) and 1,3-cyclohexyldimethylamine.

It is surprisingly found that besides possessing specially improved mechanical properties, the coating layer coated by the above coating further has a matt surface. Carbon fibers are extensively applied in manufacturing reinforced materials with its characteristics of high strength and high modulus; but in the present application, the limitation to such kind of perspective on carbon fibers is overcome and the traditional thinking is broken, and a new use of carbon fibers as a matting agent has been put forward. Due to the addition of carbon fibers, the strength and elasticity of the coating layer are kept the same to a great extent. Moreover, the surface light reflectivity can be regulated independent of mechanical properties and manufacturing dynamics within a wide range. Due to the addition of relatively large carbon fibers, the obtained polyurea coating will not be limited to the quick response theory. Meanwhile, carbon fibers provide a larger conjugated t electron system; and the system is bound with the polyurea monomer used here to ensure a special interaction with light. Carbon fibers have an absorptive capacity within a range of visible light. Therefore, in combination with the above interaction, the coating layer is colored black. The composition and spatial allocation of carbon fibers may be the reason to keep the actual mechanical properties of the coating layer and to achieve the matting effect simultaneously. This is opposite to the matt polyurea layers, which are stained black by, for example, mixing or adding aromatic components to a chain extension agent, in the prior art.

The present application relates to a solvent-free matt polyurea coating. Polyurea or polyurea refers to a polymer obtained by polyaddition of isocyanate and amine. The polymer at least partially has the following structural elements:

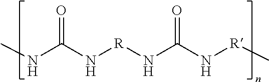

Therefore, the polymer is an amino-plastic in structure. The polyurea coating provided by the above embodiments is produced into an overall component or a portion of a component by injection molding, or the polyurea coating is coated on an overall or partial surfaces of a component, thus being produced into a polyurea molded body or a polyurea molded body portion. The polyurea molded body of the embodiments of the present application is preferably a “pure” polyurea molded body, namely, a hydroxy-carried component is not included in accordance with the Agreement on Polyurea of the Polyurea Development Association (PDA). The polyurea coating of the present application is matt. Therefore, the produced polyurea molded body or molded body portion has matt surface. Glossiness of the surface may be determined according to a standard method (for example, DIN EN ISO 2813, German matt criteria). A coating may be regarded matt if it has a glossiness greater than or equal to 5 and less than or equal to 80 at an angle of 60°. If a coating layer has a solvent content less than or equal to 5 mass %, the coating layer is determined solvent-free. In case of water as a solvent, for example, the content of the solvent may be determined by Karl Fischer, or in case of an organic solvent as a solvent, the content of the solvent may be determined by HPLC method known to a person skilled in the art very well.

The coating related herein is obtained by at least reacting polyisocyanate prepolymer with polyether amine and a chain extender. It means that the coating mainly consists of polyurea; besides the chain extender, may further comprises two major components, namely, a hardening agent and a resin component. These components are reacted to form a covalent bond between one or more components of the present application. The component of resin is called a component B in America and called a component A in Europe. The molded body may preferably comprise 70 wt % polyurea or greater than 80 wt % polyurea, or greater than 85 wt %. Furthermore, the molded body may have other conventional additives, such as, a dye, a catalyst, a rheological auxiliary, and a thickening agent/an adhesion promoter (amino-functionalized trialkoxysilane), a filler (silicate), a chain extender and a drying agent (for example, a molecular sieve).

The coating is established on the basis of a three-dimensional network linked by a covalent bond formed by a full reaction of at least dual-functional polyisocyanate prepolymer. The dual-functional polyisocyanate is represented by the general formula,

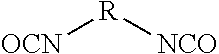

where, R represents aromatic, aliphatic or mixed hydrocarbon structures. A possible dual-functional polyisocyanate prepolymer may be, for example, derived from toluene-2,4-diisocyanate (TDI), diphenylmethane diisocyanate (MDI), hexamethylene diisocyanate (HDI, HMDI), polymerized diphenylmethane diisocyanate (PMDI), tetramethyl m-xylylene diisocyanate (TMXDI), isophorone diisocyanate (IPDI) and 4,4′-dicyclohexylmethane diisocyanate (H12MDI), and may be derived from a mixture of the above isocyanates. A quantitative ratio of a mixture prepared in the step a) of the method of the embodiments and the amount of isocyanates may be handily determined on the basis of the functionalities of the premixture from the step a) of the method and the functionalities of isocyanates. A functional group may be determined by mathematics. Accordingly, 1 mole of isocyanate functionality is used per mole of amine. But a mixing ratio may be not stoichiometric. The mixing ratio may be set from 1 to 4 (calculated by mole number of amine/mole number of isocyanate).

Polyether amine is a polymer where a primary amine group exists on a tail end of a polyether backbone. Polyether backbone is usually formed by epoxypropane, ethylene oxide or mixed ethylene oxide/epoxypropane structural units. The polyether amine used may exist in a monodisperse form, and have a constant molecular weight or more or less broad molecular weight distribution. A potential side chain may be also occupied by other primary amines. Therefore, there exists polyfunctional polyether amine having two or more functionalities of amine. Dual-functional polyether amine may be represented by, for example, the following structural formula:

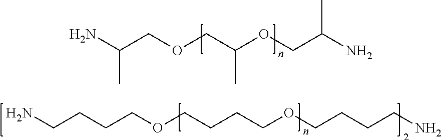

The polyether amine used has a molecular weight of 200-5000 g/mol. The functionalities of polyether amine may be preferably 2 to 4, more preferably, 2 to 3. At this time, other secondary polyether amines may be added to the mixture. This may extend the reaction rate of the treatment step b) in examples.

It is proved by facts that the main chain extender used in embodiments of the present application is particularly suitable for obtaining mechanically and optically excellent coatings. The main chain extender is selected from one or a combination of two or more of diethyltoluenediamine, 4,4-methylene bis(N-sec-butyl-cyclohexylamine), 4,4-diaminodiphenylmethane, 4,4-diaminodicyclohexylmethane, 3-[[3-[[(2-cyanoethyl)amino]methyl-3,5,5-trimethylcyclohexyl]amino]propionitrile, N,N′-isopropyl(3-aminomethyl-3,5,5-trimethylcyclohexylamine) and 1,3-cyclohexyldimethylamine. These chain extenders may be beneficial to obtaining a coating having particularly appropriate optical properties.

To obtain a matt coating, the coating comprises ground carbon fibers as a matting agent, where the carbon fibers have an average fiber length greater than or equal to 50 μm and less than or equal to 150 μm, a weight fraction greater than or equal to 4.5% and less than or equal to 25%. It has been proven that the proportion of carbon fibers is particularly suitable for obtaining an especially flexible and stable coating layer. The present application may produce a rather matt coating layer and may not damage the mechanical properties of polyurea. The average fiber length of the carbon fibers may be determined by, for example, partial microscopic images of the coating layer. The weight fraction of the carbon fibers may be also determined by a microscope via densities of the fiber and polyurea.

In a preferred embodiment of the coating, the coating has a glossiness measured at 60° according to DIN EN ISO 2813; the glossiness is greater than or equal to 10 and less than or equal to 70. The coating of the embodiment may have particularly matt optical properties and retain the required mechanical properties.

In another embodiment of the coating, the glossiness of the coating measured at 85° according to DIN EN ISO 2813 is greater than or equal to 10 and less than or equal to 70. The coating of the embodiment is obtained by a general spraying (not an atomizing spray process) and thus, may achieve matt optical properties while particularly keeping the required mechanical properties.

In another embodiment of the coating, the glossiness of the coating measured at 850 according to DIN EN ISO 2813 is less than or equal to 10. The coating of the embodiment is obtained by the atomizing spray process and thus, may achieve better matt optical properties while particularly keeping the required mechanical properties.

As a preferred embodiment, the weight fraction of the ground carbon fibers may be greater than or equal to 7.5% and less than or equal to 15%. It has been proven that the proportion of carbon fibers is particularly suitable for obtaining a specifically matt coating layer while keeping the required mechanical properties. More preferably, the weight fraction may be greater than or equal to 8.5% and less than or equal to 12.5%, and furthermore, greater than or equal to 9.0% and less than or equal to 11%.

In another preferred embodiment, the coating may further comprise a steric hindrance amine resin having a weight fraction greater than or equal to fraction 2.5% and less than or equal to 10%. The steric hindrance amine resin is also called a hindered amine light stabilizer (HALS), for example, may be liquid or solid piperidine derivatives. These substances are beneficial to forming a particularly perdurable coating layer; and the optical properties thereof are almost kept the same within the service life.

The steric hindrance amine resin may have a structure shown in the following example, where, R may be independently configured to regulate solubility thereof in the polyurea system used.

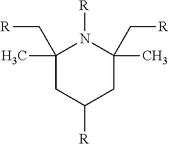

As an optional embodiment, the coating further comprises at least one or a combination of two or more of degassing agent, dispersing agent, UV stabilizer, pigment and filler. These additives may be preferably used for fine regulate the optical and mechanical properties of the coating layer.

In another preferred embodiment of the coating, an average fiber diameter of the ground carbon fibers may be greater than or equal to 2.5 μm and less than or equal to 10 μm. It has been proven that these carbon fibers are particularly suitable for obtaining a specifically matt coating. Only a small amount may obtain a matt coating whose mechanical properties are superior to those of the addition-free version. The average fiber diameter of the ground carbon fibers may be determined on a layer cross section by, for example, a microscope.

In another preferred embodiment of the coating, the coating may have a solvent with a content less than or equal to 1%. The coating related herein may have a very low solvent proportion. Therefore, these coatings are regarded free of a solvent in practical.

In an aspect of a preferred coating, based on a weight fraction, the coating has a content of polyisocyanate greater than or equal to 30% and less than or equal to 50%, a content of polyether amine greater than or equal to 20% and less than or equal to 80%, a content of chain extender greater than or equal to 5% and less than or equal to 40%, and a content of matting agent in form of ground carbon fibers greater than or equal to 5% and less than or equal to 10%; where each component may exist in form of a reaction product with each other, namely, the reaction may be performed by stages according to the requirements. A sum of each component is added up to 100%. If the above additives are added, the sum of the above components and the sum of additives may be added up to 100 wt %. Such kind of composition of the coating has been proven to be very flexible and produce enough matt effects. Moreover, the above composition ensures enough application time. Therefore, reproducible mechanical properties may be also ensured by manual application.

In a preferred embodiment of the coating, the reaction may be performed by a spray method, for example, an atomizing spray process. The atomizing spray method has been found to be particularly advantageous to produce the coating in the present application. Each component is allowed to be reacted with each other via the atomizing spray method particularly successfully and effectively, thus obtaining a particularly matt layer at the outermost surface. Without being bound to this theory, the specific surface roughness caused by the integrated carbon fibers attributes to the optical properties of the material.

Another aspect of the embodiments of the present application further relates to a kit of parts for producing a solvent-free matt polyurea coating; the kit at least comprises a container used for polyfunctional polyisocyanate prepolymer, a container used for polyether amine, as well as a mixing device and an extruding device; moreover, at least one of the above containers contains ground carbon fibers greater than or equal to 2.5 wt % and less than or equal to 20 wt %, and a fiber length of the carbon fibers is greater than or equal to 50 μm and less than or equal to 150 μm.

In the kit of parts provided by the above embodiments, mixtures in the two containers have different or similar viscosities; carbon fibers are contained to a container of the mixture with a smaller viscosity; alternatively, if the viscosities are similar, carbon fibers may be put to both containers.

The kit can provide a highly-reproducible, reliable and matt polyurea coating in the application of manual or machinery equipment. Moreover, the protection directed to the coating related in the present application may be also suitable for the kit of parts for implementing the application.

### Embodiment 1

1. Treatment Step a)

A mixture of 69 wt % polyether amine (Huntsman Jeffamine D2000), 21 wt % diethyltoluenediamine (Lonzacure DETDA 80) and 10 wt % carbon fiber particulates was produced at room temperature by mechanical stirring. The fiber particulates have an average fiber length of 75-85 μm, a density of 1.7-1.9 g/cm³ and a diameter of 6-8 μm. Mechanical properties of the fiber particulates are preferably as follows: 2.5-4 GPa tensile strength, 150-250 GPa E modulus and 1-2% elongation at break. Fibers within these ranges are chosen to obtain good mechanical and optical properties. The fibers were mixed until an even reaction premix was obtained.

2. Treatment Step b)

The reaction premix from the treatment step a) was placed in a container. Another container contains polyisocyanate prepolymer (Huntsman Suprasec 2054). The reaction premix and polyisocyanate prepolymer were sprayed onto a workpiece by a sprayer, for example, a Graco reactor, to obtain a surface coating layer. A spray gun was rapidly moved to produce mist such that a rough surface was formed on a substrate. A mixing ratio of the reaction premix from the treatment step a) to the polyisocyanate prepolymer of the present step is 1:1.

### Embodiment 2

1. Treatment Step a)

A mixture of 51.5 wt % polyether amine (24.5 wt % Huntsman Jeffamine D2000+19 wt % Huntsman JeffamineD400+7.5 wt % Huntsman JeffamineT5000+0.5 wt % auxiliary adhesive), 39.5 wt % chain extender (7.9 wt % Lonzacure DETDA 80+31.6 wt % Jefflink754) and 9 wt % carbon fiber particulates were produced at room temperature by mechanical stirring. The fiber particulates have an average fiber length of 50 μm, a density of 1.7-1.9 g/cm³ and a diameter of 6-8 μm. Mechanical properties of the fiber particulates are preferably as follows: 2.5-4 GPatensile strength, 150-250 GPa E modulus and 1-2% elongation at break. Fibers within these ranges are chosen to obtain good mechanical and optical properties. The fibers were mixed until an even reaction premix was obtained.

2. Treatment Step b)

The reaction premix from the treatment step a) was placed in a container. Another container contains polyisocyanate prepolymer (Huntsman Suprasec 2067). The reaction premix and polyisocyanate prepolymer were sprayed onto a workpiece by a sprayer, for example, a Graco reactor to obtain a surface coating layer. A spray gun was rapidly moved to produce mist such that a rough surface was formed on a substrate. A mixing ratio of the reaction premix from the treatment step a) to the polyisocyanate prepolymer of the present step is 1:1.

### Embodiment 3

1. Treatment Step a)

A mixture of 51.5 wt % polyether amine (24.5 wt % Huntsman Jeffamine D2000+19 wt % Huntsman JeffamineD400+7.5 wt % Huntsman JeffamineT5000+0.5 wt % auxiliary adhesive), 39.5 wt % chain extender (7.9 wt % Lonzacure DETDA 80+31.6 wt % Jefflink754) and 9 wt % carbon fiber particulates were produced at room temperature by mechanical stirring. The fiber particulates have an average fiber length of 150 μm, a density of 1.7-1.9 g/cm³ and a diameter of 6-8 μm. Mechanical properties of the fiber particulates are preferably as follows: 2.5-4 GPa tensile strength, 150-250 GPaE modulus and 1-2% elongation at break. Fibers within these ranges are chosen to obtain good mechanical and optical properties. The fibers were mixed until an even reaction premix was obtained.

2. Treatment Step b)

The reaction premix from the treatment step a) was placed in a container. Another container contains polyisocyanate prepolymer (Huntsman Suprasec 2067). The reaction premix and polyisocyanate prepolymer were sprayed onto a workpiece by a sprayer, for example, a Graco reactor to obtain a surface coating layer. A spray gun was rapidly moved to produce mist such that a rough surface was formed on a substrate. A mixing ratio of the reaction premix from the treatment step a) to the polyisocyanate prepolymer is 1:1.

### Comparative Example 1

Compared with Embodiment 1, the rest was the same except no carbon fiber was added.

### Comparative Example 2

Compared with Embodiments 2 and 3, the rest was the same except no carbon fiber was added.

Performance Tests

1. A glossiness of the surface coating layer formed by atomizing spraying in each embodiment at 85° and a glossiness of the surface coating layer formed in an atomizing-free way in each embodiment at 60° were measured according to DIN EN ISO 2813.

2. Glossiness of the surface coating layer formed by atomizing-free spraying in each comparative example at 85° and 60° was measured according to DIN EN ISO 2813.

3. Tensile strength and elongation at break of the surface coating layer formed by spray in each embodiment and each comparative example were measured.

The performance test results are shown in Table 1.

TABLE 1
Performance comparison table

| | | Comparative | | | Comparative |
|---|---|---|---|---|---|
| Performance | Embodiment 1 | Example 1 | Embodiment 2 | Embodiment 3 | Example 2 |
| Glossiness at | 38 | 95 | 38 | 33 | 87 |
| 60° | | | | | |
| Glossiness at | 0.1 | 64 | 0.5 | 3.5 | 72 |
| 85° | | | | | |
| Tensile | 21.1 | 19.9 | 16.5 | 17.3 | 16 |
| strength/MPa | | | | | |
| Elongation at | 220 | 170 | 170 | 182 | 171 |
| break/% | | | | | |

It can be seen from Table 1 that compared with the comparative examples without carbon fibers, the coating layer formed by spraying the coating provided in the embodiments of the present application has a very low glossiness and has a matt surface, and meanwhile, may keep mechanical properties similar to those of the existing coating layers (see Embodiment 2), and even has mechanical properties superior to those of the existing coating layers (see Embodiments 1 and 3).

1. A solvent-free matt polyurea coating, which is obtained by carrying out a reaction through at least following components:
a) a polyisocyanate prepolymer;
b) a polyether amine;
c) a main chain extender, wherein
the coating further comprises ground carbon fibers as a matting agent, the carbon fibers have an average fiber length greater than or equal to 50 μm and less than or equal to 150 μm, a weight fraction greater than or equal to 4.5% and less than or equal to 25%; the main chain extender is selected from one or a combination of two or more of diethyltoluenediamine, 4,4-methylene bis(N-sec-butyl-cyclohexylamine), 4,4-diaminodiphenylmethane, 4,4-diaminodicyclohexylmethane, 3-[[3-[[(2-cyanoethyl)amino]methyl-3,5,5-trimethylcyclohexyl]amino]propionitrile and 1,3-cyclohexyldimethylamine.

2. The coating according to claim 1, wherein the polyisocyanate prepolymer is a polyfunctional polyisocyanate prepolymer having at least two or more isocyanate functionalities.

3. The coating according to claim 2, wherein the polyisocyanate prepolymer is selected from one or a combination of two or more of toluene-2,4-diisocyanate (TDI), diphenylmethane diisocyanate (MDI), hexamethylene diisocyanate (HDI, HMDI), polymerized diphenylmethane diisocyanate (PMDI), tetramethyl m-xylylene diisocyanate (TMXDI), isophorone diisocyanate (IPDI) and 4,4′-dicyclohexylmethane diisocyanate (H12MDI).

4. The coating according to claim 2, wherein the polyether amine is a polyfunctional polyether amine having at least two or more amine functionalities, and has a molecular weight of 200-5000 g/mol.

5. The coating according to claim 4, wherein a molar ratio of amine to isocyanate in the coating is 1-4.

6. The coating according to claim 1, wherein the coating has a glossiness greater than or equal to 10 and less than or equal to 70 measured at 600 according to DIN EN ISO 2813.

7. The coating according to claim 1, wherein the coating has a glossiness greater than or equal to 10 and less than or equal to 70 measured at 85° according to DIN EN ISO 2813.

8. The coating according to claim 6, wherein the coating has a glossiness greater than or equal to 10 and less than or equal to 70 measured at 85° according to DIN EN ISO 2813.

9. The coating according to claim 1, wherein the ground carbon fibers have a weight fraction greater than or equal to fraction 7.5% and less than or equal to 15%.

10. The coating according to claim 1, wherein the coating further comprises a steric hindrance amine resin having a weight fraction greater than or equal to fraction 2.5% and less than or equal to 10%.

11. The coating according to claim 1, wherein the coating further comprises one or a combination of two or more of degassing agent, dispersing agent, UV stabilizer, pigment and filler.

12. The coating according to claim 10, wherein the coating further comprises one or a combination of two or more of degassing agent, dispersing agent, UV stabilizer, pigment and filler.

13. The coating according to claim 1, wherein the ground carbon fibers have an average fiber diameter greater than or equal to 2.5 μm and less than or equal to 10 μm.

14. The coating according to claim 1, wherein the coating has a solvent content less than or equal to 1%.

15. The coating according to claim 1, wherein based on a weight fraction, the coating has a content of polyisocyanate greater than or equal to 30% and less than or equal to 50%, a content of polyether amine greater than or equal to 20% and less than or equal to 80%, a content of chain extender greater than or equal to 5% and less than or equal to 40%, and a content of the matting agent in form of the ground carbon fibers greater than or equal to 5% and less than or equal to 10%.

16. The coating according to claim 1, wherein based on a weight fraction, the coating has a content of polyisocyanate greater than or equal to 30% and less than or equal to 50%, a content of polyether amine greater than or equal to 20% and less than or equal to 80%, a content of chain extender greater than or equal to 5% and less than or equal to 40%, and a content of the matting agent in form of the ground carbon fibers greater than or equal to 5% and less than or equal to 10%; where each component exist in form of a reaction product with each other.

17. The coating according to claim 1, wherein the reaction is performed by an atomizing spray process.

18. A kit of parts for producing the solvent-free matt polyurea coating, wherein the kit at least comprises a container used for polyfunctional polyisocyanate prepolymer, a container used for polyether amine, as well as a mixing device and an extruding device; at least one of the above containers contains ground carbon fibers greater than or equal to 2.5 wt % and less than or equal to 20 wt %, and a fiber length of the carbon fibers is greater than or equal to 50 μm and less than or equal to 150 μm.
